(19) United States
(12) Patent Application Publication
(10) Pub. No.: US 2002/0082722 A1
(43) Pub. Date: Jun. 27, 2002

(54) Addon mechanism for a control system based on an extension data field

(76) Inventors: Jens Ansgar Rosenberg, Nuemberg (DE); Peter Wagner, Hersbruck (DE)

Correspondence Address: BAKER & BOTTS, 30 ROCKEFELLER PLAZA, NEW YORK, NY, 10112

(21) Appl. No.: 09/968,309

(22) Filed: Oct. 1, 2001

(30) Foreign Application Priority Data
Dec. 22, 2000 (DE) 100 659 55.1
Jun. 15, 2001 (DE) 101 289 58.8

(51) Int. Cl. G06F 17/00

(52) U.S. Cl. 700/30; 700/28; 700/29

(57) ABSTRACT

Flexible extension of a control system needs to be possible without touching the original object model and hence the control software. To this end, the invention proposes attaching extension data elements (Ext_{—}1, Ext_{—}2) which contain tool- or user-specific data to object data (Obj_{—}2). An object type can then be instantiated selectively for the existing or new tools (SnapIn_{—}1, SnapIn_{—}2. This allows extensions to be instantiated subsequently without affecting the essence of the existing object model.

### BACKGROUND OF THE INVENTION

Modern industrial controllers generally comprise an “engineering system” and a “runtime system”. The engineering system is used to develop a control program which is then subsequently loaded into the runtime system. The runtime system then ensures the time sequence control for the system to be controlled.

The functionality of the system to be controlled and/or of the runtime system can be expressed by an object model. The object model is effective in the engineering system and/or runtime system and is the basis for the engineering of the controller, for example, startup and programming etc. Furthermore, the object model is the basis for the data storage of the controller. The elements of the object model can be categorized into various object types. The object type is the software engineering form of a description of object instances. In the simplest form, this description relates to the data structure represented by an object instance in the memory. In systems today, the object type also describes operations which can be carried out on these data structures and thus also lends functionality to the object instances. An example of one of these object types is program containers used for managing and storing user programs. Other object types are technological object types, such as for positioning axes, synchronism axes, measuring gages, cam disks etc., the functionality of those object types being stored in the respective object type on a data engineering basis. Another significant object type is “devices” used for managing and storing hardware configuration settings.

All object types can be instantiated, i.e. can be embodied specifically. Thus, for example, a synchronism object can be allocated a specific transmission ratio. The technological object types can be organized in the form of technological packets. Instantiation is generally effected in the engineering system. Loading the instantiated objects into the runtime system initiates the instantiation of corresponding objects in the runtime system, to which objects the data of the objects from the engineering system are transmitted.

An object instance is first a data structure in the memory of a computer system. From one object type, it is possible to instantiate any desired number (to the extent permitted by the underlying computer system) of object instances. In this context, the size and organization of the data structure of each object instance follows the description provided by the object type. Object instances are set up at the execution time of an editor, that is to say while the program system is being executed on a computer system in the engineering system.

The object model comprises a set of object types and describes the relationships between object instances instantiated from the object types. The complexity of creating new object types to be inserted into a complex object model can be comparatively great.

In the engineering system, various tools can be used to access objects (instances) of particular object types. That is to say that the object types are defined when the software system is created and cannot be changed again in the engineering system. Accordingly, the engineering system permits one or more views to the instances of particular object types. Within the context of programming, these may be, by way of example, various editors for textual or graphical user programming. The tools and views of the engineering system are also called SnapIns. Besides the SnapIns present in the basic system, other SnapIns can be added to the engineering system.

In principle, engineering systems, like any other software, are also subject to constant renewal, extension and improvement. However, with today's implementation mechanisms for control extensions, the problems discussed below often arise. The introduction of a new programming view, e.g. the introduction of graphical programming in addition to textual programming, is today not possible in integrated fashion without extending the basic functionality of the engineering system. A possible external extension using external tools requires dedicated data storage, which is then not integrated into the existing system. The extension of an existing, for example graphical, programming language by additional programming icons, which requires extension of the data storage, is generally not possible without touching or extending the existing engineering system. Thus, for example, an existing flowchart editor cannot readily be extended by icons for particular library functions. In addition, today's OEM interfaces afford only a specific and restricted depth of integration into the engineering system. Finally, extensions of the engineering system functionality using external tools generally entail consistency problems in the data storage.

### SUMMARY OF THE PRESENT INVENTION

The objective of the present invention is to describe, in relation to controllers, a method for flexibly extending control systems which does not require the original object model to be touched. The present invention achieves this objective by means of an apparatus for controlling or regulating a system based on an object model which represents the functionality of a runtime system and/or of the system to be controlled or to be regulated. The apparatus has a data processing device for processing first object types which have a predetermined data structure, which are part of the object model and which can be instantiated for objects. The data processing device is able to be used to create and/or process second object types which respectively relate to one or more of the first object types such that, upon instantiation, an object of the first object type can be extended with at least one extension data field specific to the second object type.

Further, the objective of the present invention is achieved by a method for controlling or regulating a system based on an object model which represents the functionality of a runtime system and/or of the system to be controlled or to be regulated. The object model comprises a first object type which has a predetermined data structure which relates to the first object type, by reading-in or creating a second object type, and instantiating the second object type. An object associated with the first object type is formed, and an extension data field based on the second object type is attached thereto.

The inventive extension mechanism advantageously permits scalable functional extension of the control software with a great depth of integration in the engineering system without touching the underlying software. The extensions can be in a form such that all existing engineering operations and transactions on the object types, e.g. browser, viewer, copying, inserting, importing, exporting, etc., also act on the extensions and can be used in a familiar manner.

Another advantage is that OEM extensions for new object types and new viewers are generically possible and require no changes to the basic software in the engineering system.

### BRIEF DESCRIPTION OF THE DRAWINGS

The present invention is now explained in more detail below with reference to the drawings, in which:

FIG. 1 shows a data structure diagram of the inventive mechanism;

FIG. 2 shows a diagram of the functional connection between tools and objects; and

FIG. 3 shows a combination of the structures shown in FIGS. 1 and 2.

### DETAILED DESCRIPTION OF THE INVENTION

The exemplary embodiment illustrates below one preferred application of the present invention. Frequently, a new view or editor needs to store separate data on the object instances it displays or processes. Since neither the form nor the scope of these data are known at the instant at which the object model is created by programming, no appropriate data fields can be firmly reserved in the data structures defined by the object types. To solve this problem, one or more extensions or extension data fields Ext_1, Ext_2 are introduced. Extensions are independent objects whose descriptions do not appear in the object model of the control system. Rather, the types described by extensions are parts of the “private” object model of the SnapIns which introduce their extensions into the engineering system.

Specific data fields describing the data structure are provided in the object types of the object model of the control system. SnapIns, which might attach one or more extensions to an object instance, enter rules into these data fields. These rules allow the engineering system to instantiate extension objects of the desired kind. An extension which has been allocated to an object instance in this manner forms a unit with this object instance, i.e. it is stored, shifted, deleted, exported, etc. with the object instance. The object model of the control system, i.e. the basic object model, is not modified when extensions are added.

A project browser in the engineering system shows the project structure by displaying object instances and their links. There is a direct connection between project structure and object model to the extent that the object model contains, among other things, information regarding which object instances can possibly be created in a project and which relationships can arise between the instances of particular types.

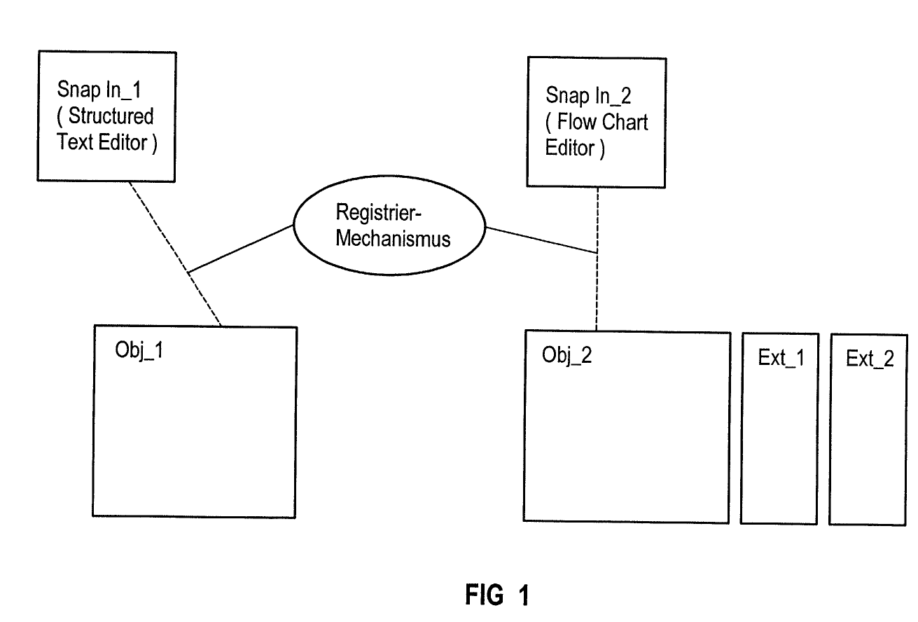

The user can observe and edit object data in appropriate windows. In the present example, the original software contains a structured text editor as SnapIn_1 in the workbench for the controller shown in FIG. 1. The basic engineering system of a development department or the engineering system of a system constructor provides an object Obj_1, registered for the structured text editor on the basis of its object type, after an object type has been instantiated. This means that the structured text editor is retrieved automatically when navigating onto the object Obj_1 in the project browser, so that the object Obj_1 thus becomes editable.

In addition, the basic engineering system provides an object Obj_2 which can, in principle, also be edited using the structured text editor. The object Obj_2 has been extended by two extension data elements Ext_1 and Ext_2. The number of extension data elements which are linked to the basic object can be chosen at random. The object Obj_2 having the two extension data elements Ext_1 and Ext_2 is registered for the additional flowchart editor SnapIn_2 in the present case. This means that the flowchart editor SnapIn_2 is automatically retrieved when navigating onto the extended object Obj_2 in the project browser, and the object is available for editing in the flowchart editor. In addition, the extension data elements can contain user-specific data, e.g. relating to an editor preferred by the user.

FIG. 1 thus illustrates an extension mechanism which can be used to extend a basic engineering system by an additional editor SnapIn_2 without changing the original functionality. The tools and the views for an object type are extended by adding additional data on the object type. In this context, data extensions are attached to existing object types and are homogeneously integrated into the existing data storage without extending the underlying engineering system software. A registration mechanism allows SnapIns or similar extension tools (SnapIn_2) to register on the object type with the respectively provided number of extensions and to create appropriate object instances for the tools and views. This type of extension allows them to be integrated into the existing project data storage, and hence permits consistent data storage. It also allows them to be integrated into the existing object model, i.e. permits integration into all engineering functionalities connected to the object model, such as project browsers.

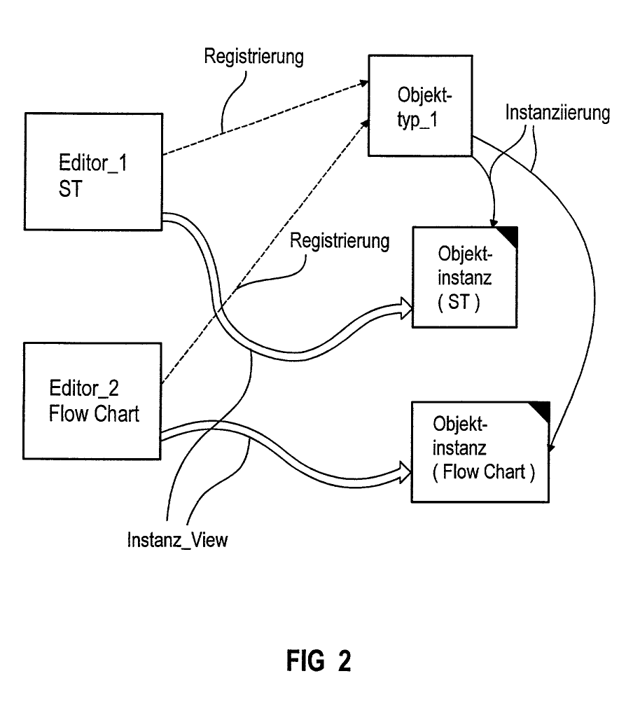

FIG. 2 shows a specific example of the registration of a plurality of editors for an object type and the instantiation thereof in a plurality of objects. As shown, an existing structured text editor (or one which is to be newly added) Editor_1 and also an existing flowchart editor (or one which is to be newly added) Editor_2 are registered for an Object type_1. The Object type_1 can thus be instantiated in the structured text format and likewise in the flowchart format. A respective Instance View link then ensures that the Structured Text object instance is edited by the structured text editor and the Flowchart object instance is edited by the flowchart editor on request.

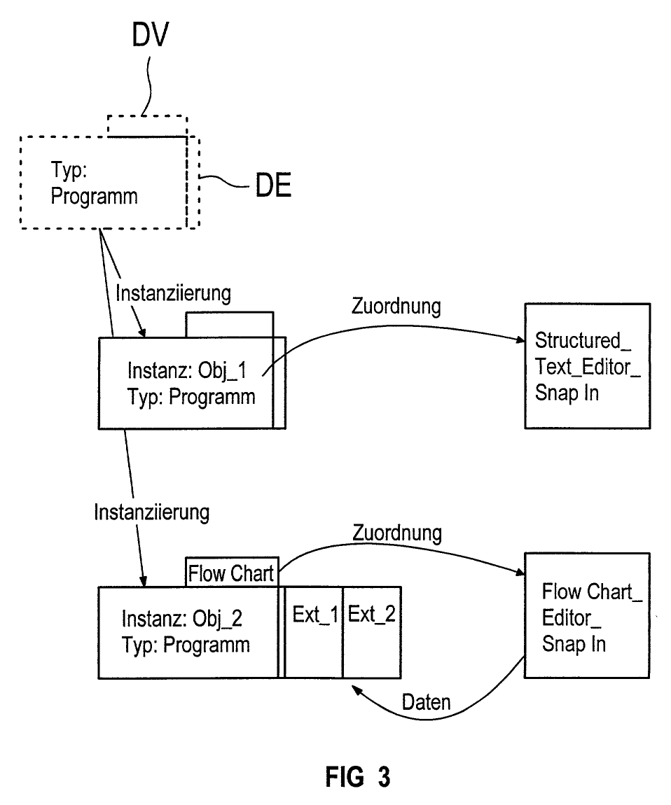

A combination of the embodiments of FIG. 1 and FIG. 2 is shown in FIG. 3. A “program” object type is provided with a data field DV for a virtual type when created in the engineering system. The data field DV can store a Virtual Type ID list or a Virtual Type ID field which can hold the registration information for an additional tool or SnapIn. In addition, a data field DE for attaching extensions is appended to the “program” object type.

The “program” object type can now be instantiated in the engineering system in two ways. It may be instantiated for an object Obj_1, for which the data field DV is not used. The association with an editor is therefore made on a standard basis using the “program” object type. The other possible instantiation produces an object Obj_2., in which case the data field DV is used for registration for a virtual type which is not part of the basic object model. As shown in FIG. 3, the object Obj_2 has been registered for the flowchart editor, i.e., the Virtual Type ID field DV contains association information for the flowchart editor.

The flowchart editor uses flowchart-specific information which cannot be stored in standard objects. While the object Obj_2 has a data field DE available, the flowchart-specific information can be stored in one or more extensions Ext_1, Ext_2. The user can thus use individual SnapIns to the full extent.

In summary, the control system described above has the following advantages:

the functionality is represented using an object model;

the object model is effective in the engineering system and/or runtime system;

the object model is the basis for the engineering of the controller (e.g. for startup, programming, etc.);

the object model is the basis for the data storage of the controller;

the controller's engineering system based on the object model can be flexibly extended without touching the engineering system by introducing extensions;

all existing engineering operations and transactions on the object types (e.g. browser, viewer, copying, inserting, importing, exporting etc.) also act on the extensions and can be used in the same way, because the extensions are made directly on the object;

OEM extensions for extensions of the object types, new views to existing object types, new object types are generically possible and require no change to the basic software (engineering system);

an extension mechanism having a generic interface is available in order to make extensions in the user interface (new editors, new views) and/or in the data storage;

new engineering functionalities and new engineering views to existing object types in the object model can be added;

existing object types can be extended by creating additional data on the object type; and

new object types can be added to the available object model at any point.

We claim:

1. An apparatus for controlling or regulating a system based on an object model which represents the functionality of a runtime system and/or of the system to be controlled or to be regulated, comprising a data processing device for processing a first object type having a predetermined data structure which is part of the object model, and which can be instantiated for objects, wherein the data processing device is used to create and/or process a second object type which essentially matches the first object type but comprises at least one extension data field specific to the second object type.

2. The apparatus according to claim 1, wherein the data processing device is used to attach at least one type data field to one of the first object types.

3. The apparatus according to claim 2, wherein the at least one type data field can store registration information for at least one standard or additional tools for a specific editor.

4. The apparatus according to claim 3, wherein one of the standard tools is a standard editor and/or standard view, and one of the additional tools is an extended editor and/or view having extended functionality, which permit access to the extension data field.

5. The apparatus according to claim 3, wherein standard tools include a browser, viewer, copying, inserting, importing and exporting, said standard tools capable of being used on object types with or without extension data fields in the respective standard form.

6. The apparatus according to claim 1, further comprising an extension mechanism with a generic interface for extensions in a user interface and/or in data storage.

7. The apparatus according to claim 1, wherein the at least one extension data field comprises an extension identification list which can be used to identify extension data.

8. The apparatus according to claim 1, wherein the extension data field can store data for functionalities which are extended as compared with the basic object model, selected from graphics data and mathematical functions.

9. A method for controlling or regulating a system based on an object model which represents the functionality of a runtime system and/or of the system to be controlled or to be regulated, the object model having a first object type which has a predetermined data structure and can be instantiated for objects, comprising a second object type which relates to the first object type, and
instantiating the second object type, forming an object associated with the first object type and attaching thereto an extension data field based on the second object type.

10. The method according to claim 9, wherein at least one type of a data field is attached to the first object type in order to associate it with a SnapIn.

11. The method according to claim 9, wherein the extension data field comprises data for functionalities which are extended as compared with the object model.

12. The method according to claim 9, wherein additional tools, which are not associated with the object model are utilized to access the extension data field when the second object type is formed.

13. The method according to claim 9, wherein standard tools associated with the object model are used to access the extension data field on first and second object types.

14. The method according to claim 9, wherein the extension data field stores data for functionalities which are extended as compared with the object model.

15. The method according to claim 14, wherein the data are selected from graphics and mathematical functions.
